(19) United States
(12) Patent Application Publication
(10) Pub. No.: US 2019/0392435 A1
(43) Pub. Date: Dec. 26, 2019

(54) METHODS AND SYSTEMS FOR FACILITATING AN ONLINE PAYMENT TRANSACTION

(71) Applicant: Mastercard International Incorporated, Purchase, NY (US)

(72) Inventors: Piyush Sharma, Pune (IN); Navneet Jain, Pune (IN)

(21) Appl. No.: 16/392,176

(22) Filed: Apr. 23, 2019

(30) Foreign Application Priority Data
Jun. 21, 2018 (SG) 10201805333S

(51) Int. Cl. G06Q 20/38; G06Q 20/08; G06Q 20/40

(52) U.S. Cl. CPC G06Q 20/385; G06Q 20/40; G06Q 20/085

(57) ABSTRACT

Embodiments provide a method for facilitating an online payment transaction. The method includes receiving, by a first server, a transaction ID generation request in a payment authentication interface associated with the first server. The transaction ID generation request is generated upon selection of a transaction ID generation option by a user in the payment authentication interface. The method further includes generating, by the first server, a transaction ID valid for the online payment transaction upon reception of the transaction ID generation request. The method further includes receiving a transaction ID validation message from a second server in response to the user providing the transaction ID at an application interface associated with the second server. The method further includes facilitating, by the first server, the online payment transaction upon reception of the transaction ID validation message.

### CROSS-REFERENCE TO RELATED APPLICATION

This application is a U.S. National Stage filing under 35 U.S.C. § 119, based on and claiming benefits of and priority to Singapore Patent Application No. 10201805333S filed on Jun. 21, 2018. The entire disclosure of the above application is incorporated herein by reference for all purposes.

### TECHNICAL FIELD

The present disclosure relates to online payment transactions and, more particularly to, methods and systems for approving an online transaction carried out over the Internet by authenticating an identity of a user.

### BACKGROUND

With the advent of the Internet, enterprises have been increasingly using the web or mobile based platforms for reaching out to their customers. With increasing users accessing the Internet, electronic commerce or “e-commerce” and internet banking are becoming widely popular. An e-commerce transaction and/or an internet banking transaction typically end with authentication of a customer, who initiates the transaction. Upon authentication of the customer, settlement of funds take place between a financial account of the customer and an acquirer's account (i.e. a merchant's account associated with the web or mobile based e-commerce platforms).

In a typical online transaction (e-commerce or online banking) scenario, passwords or pass keys are widely used to allow authorized access to sensitive customer data. In an example scenario, when a customer wishes to gain authorized access to a banking website, the user must enter his/her login credentials (user name and a password). The credentials are then checked against entries in a secure database and access is granted if the login credentials match a database entry. This is an example of a one-step authentication/verification. However, it is very easy for untrusted sources to obtain the user's login credentials. One-step authentication therefore provides relatively weak protection.

In India, in most present scenarios, two-step authentication has been implemented as per policies and guidelines mandated by the Reserve Bank of India (RBI). The two-step authentication generally includes a banking website sending a security message to the customer on a registered mobile phone number of the customer. Banking websites utilize customers' registered mobile phone numbers because a one-to-one relationship is assumed to exist between a customer and his or her mobile phone and that the phone is always in the customer's possession. Currently, the preferred means of delivering security messages to the customer's mobile phone number is Short Messages Service (SMS) messages. The security message normally includes a unique one-time password (OTP) which the customer manually enters into a secure environment of the banking website. While this technology adds an extra layer of security, there are several operational drawbacks with implementation of this technology. One such drawback is non-availability of SIM or cellular network. These OTPs have generally have a validity period within which they have to be used once. Many a times, due to failure in cellular network connection or loss of signal, the text message may not be received on time. Further, many times the customer's phone may be switched off.

Another drawback associated with this technique is theft of the customer's mobile phone. There are chances that the mobile phone can be stolen by untrusted sources. It may be easy for any unauthorized sources to obtain the rest of the information associated with the customer, such as, the log in credentials to a banking website as long as the customer's mobile phone and the registered mobile phone number are in their possession and thereby commit fraud.

Hence, in light of the foregoing discussion, there appears to be a need for a solution/technique that facilitates an online transaction without a customer having to depend on availability of a mobile phone or a registered mobile phone number in the customer's possession. Further, there appears to be a need for a technique that facilitates the online transaction without the customer having to worry about availability of cellular (SIM) network for receiving a password for authentication purposes while performing the online transaction.

### SUMMARY

Various embodiments of the present disclosure provide systems, methods, electronic devices and computer program products for facilitating an online payment transaction. Various embodiments provide systems, methods, electronic devices and computer program products for authenticating a user/customer identity for approval of the online payment transaction. Further, embodiments provide systems and methods for generating a transaction identifier (transaction ID) and a one-time password (OTP) for authenticating the user.

An embodiment provides a method for facilitating an online payment transaction. The method includes receiving, by an issuer server, a transaction ID generation request in a payment authentication interface associated with the issuer server. The transaction ID generation request is generated upon selection of a transaction ID generation option by a user in the payment authentication interface. The method further includes generating, by the issuer server, a transaction ID valid for the online payment transaction upon reception of the transaction ID generation request. The method further includes receiving a transaction ID validation message from a payment server in response to the user providing the transaction ID at an application interface associated with the payment server. The method further includes facilitating, by the issuer server, the online payment transaction upon reception of the transaction ID validation message.

Another embodiment provides an issuer server for facilitating an online payment transaction. The issuer server includes a memory comprising stored instructions and a processor configured to execute the stored instructions to cause the issuer server to perform at least receiving a transaction ID generation request in a payment authentication interface associated with the issuer server. The transaction ID generation request is generated upon selection of a transaction ID generation option by a user in the payment authentication interface. The issuer server is further caused to perform generating a transaction ID valid for the online payment transaction upon reception of the transaction ID generation request. The issuer server is further caused to receive a transaction ID validation message from a payment server in response to the user providing the transaction ID at an application interface associated with the payment server. The issuer server is further caused to perform facilitating the online payment transaction upon reception of the transaction ID validation message.

Another embodiment provides another method for facilitating an online payment transaction. The method includes receiving, by a payment server associated with a payment network, a transaction ID provided by a user in an application interface associated with the payment server. The transaction ID is generated by an issuer server in response to a transaction ID generation request initiated by the user in a payment authentication interface associated with the issuer server. The method includes sending a transaction ID validation message to the issuer server through the payment network in response to the user providing the transaction ID at the application interface associated with the payment server. The method further includes facilitating the online payment transaction upon reception of the transaction ID validation message by the issuer server within a first pre-defined time period.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an example environment, in which at least some example embodiments of the present disclosure can be implemented;

FIG. 2A represents a sequence flow diagram representing a method of facilitating an online payment transaction, in accordance with an example embodiment;

FIG. 2B represents a sequence flow diagram representing another method of facilitating an online payment transaction, in accordance with an example embodiment;

FIG. 3 represents a simplified sequence flow diagram representing a method of facilitating an online payment transaction, in accordance with another example embodiment;

FIG. 4 represents a simplified sequence flow diagram representing a method of facilitating an online payment transaction, in accordance with yet another example embodiment;

FIG. 5 represents a simplified sequence flow diagram representing a method of facilitating an online payment transaction, in accordance with still another example embodiment;

FIG. 6 is an example representation of a payment authentication interface/page on an issuer website managed by an issuer server, in accordance with an example embodiment;

FIG. 7A is an example representation of an application interface facilitated by a payment server and presented on a user device, in accordance with an example embodiment;

FIG. 7B is another example representation of the application interface facilitated by the payment server and presented on the user device, in accordance with an example embodiment;

FIG. 8 is an example representation of a payment authentication interface/page, in accordance with an example embodiment;

FIG. 9 illustrates a flow diagram of a method for facilitating an online payment transaction, in accordance with one embodiment of the present disclosure;

FIG. 10 illustrates a flow diagram of a method for facilitating an online payment transaction, in accordance with another embodiment of the present disclosure;

FIG. 11 illustrates a flow diagram of a method for facilitating an online payment transaction, in accordance with yet another embodiment of the present disclosure;

FIG. 12 is a simplified block diagram of a server system used for facilitating an online payment transaction, in accordance with one embodiment of the present disclosure;

FIG. 13 is a simplified block diagram of an issuer server for facilitating an online payment transaction, in accordance with one embodiment of the present disclosure;

FIG. 14 is a simplified block diagram of an acquirer server for facilitating an online payment transaction, in accordance with one embodiment of the present disclosure;

FIG. 15 is a simplified block diagram of a payment server for facilitating an online payment transaction, in accordance with one embodiment of the present disclosure; and

FIG. 16 shows simplified block diagram of a user device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used throughout the description refers to a financial account that is used to fund the financial transaction (interchangeably referred to as “payment transaction”). The “acquirer account” used throughout the description refers to a financial account of a merchant or any entity which receives the fund from the issuer account. Further, the “acquirer account” used throughout the description refers to a financial account of a beneficiary. Herein, beneficiary refers to an individual or an entity who receives money from someone. Examples of the issuer account and the acquirer account include, but are not limited to a savings account, a credit account, a checking account and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by PayPal®, and the like.

The term “payment card”, used throughout the description, refer to a physical or virtual card linked with a financial or payment account that may be presented to a merchant or any such facility in order to fund a financial transaction via the associated payment account. Examples of the payment card include, but are not limited to, debit cards, credit cards, prepaid cards, virtual payment numbers, virtual card numbers, forex card, charge cards and stored-value cards, digital wallets and Google® pay, etc. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Overview

Various embodiments of the present disclosure provide systems, methods, electronic devices and computer program products for facilitating an online payment transaction. Various embodiments provide systems, methods, electronic devices and computer program products for authenticating a user/customer for approval of the online payment transaction. Further, embodiments provide systems and methods for generating a transaction ID and a one-time password (OTP) for authenticating the user.

Embodiments provide a user device associated with the user/customer and a server system associated with a payment network for facilitating the online transaction. The user initiates an online payment transaction at the user device for purchase of goods or services on an e-commerce portal. To complete the online payment transaction, the user is redirected from the e-commerce portal to an issuer (banking) portal through a payment gateway (e.g., the server system). An issuer server managing the issuer portal facilitates a payment authentication interface (internet banking interface) at the user device. The user may have to enter his/her login credentials at the payment authentication page on the issuer portal. The issuer server provisions for a transaction ID generation option in the payment authentication interface. Upon selection of the transaction ID generation option by the user, a transaction ID generation request is received by the issuer server. The issuer server generates a transaction ID upon reception of the transaction ID generation request. The issuer server facilitates copying of the transaction ID from the payment authentication interface and allows provision of the transaction ID at an application interface provided by an application managed by the server system (e.g., a payment server). The user device is facilitated with an instance of the application therein which presents the application interface on the user device. The user can paste the transaction ID generated by the issuer server in the application interface. Additionally or alternatively, the transaction ID may be manually typed in at the application interface. Upon reception of a transaction ID validation message or upon reception of a confirmation of provision of the transaction ID at the application interface, the issuer server approves the online payment transaction thereby authenticating the user. The application may be a desktop application or a mobile application managed by the server system associated with the payment network.

The issuer server further determines whether a regulatory body for the financial transactions mandates a two-step verification in a country where an issuer associated with the issuer server is present. Based on the determination, the issuer server, upon reception of the transaction ID validation message, generates a security code (e.g., a one-time password). The security code is displayed at the application interface on the user device. The user then manually enters the security code at the payment authentication interface of the issuer portal. Upon reception of the security code, the issuer server approves the online payment transaction thereby authenticating the user.

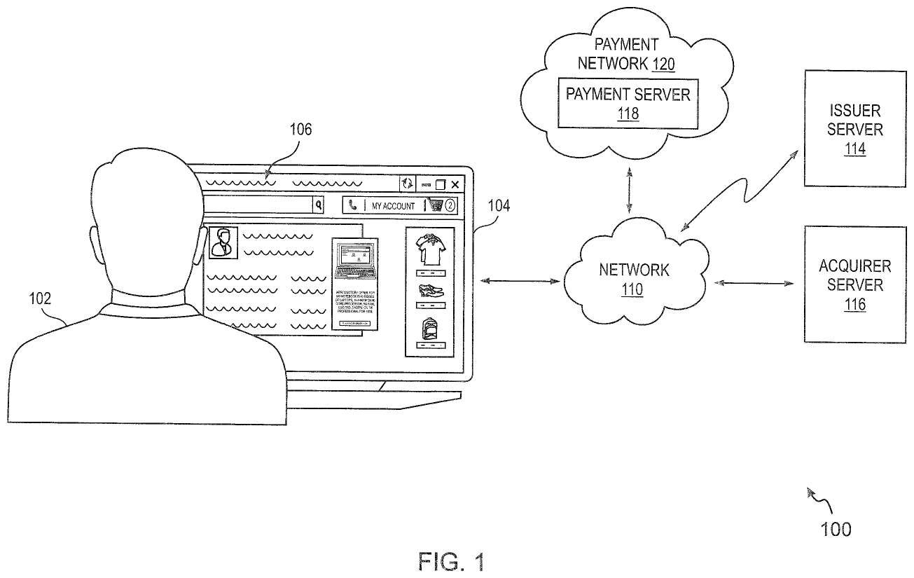

FIG. 1 illustrates an example representation of an environment 100, in which at least some example embodiments of the present disclosure can be implemented. The environment 100 as illustrated in FIG. 1 depicts a user 102 associated with a user device 104. The user 102 is further depicted as accessing a website/merchant interface 106 on the user device 104. The website 106 is a digital interface or an interaction channel associated with a merchant/enterprise for selling goods and services or any offerings that require financial transaction with the customers such as the user 102. The website 106 may be hosted on a remote web server (not shown) and may retrieve one or more web pages from the remote web server over a network 110 upon navigation through the website 106.

As an example, the user device 104 of FIG. 1 is depicted as a desktop computer. However, it shall be understood that, the user device 104 is not limited to a desktop computer and can include any electronic device of the likes of a desktop computer and having the capability to communicate with other devices via the Internet/network 110. Examples of the user device 104 include, but are not limited to, a smartphone, a tablet, a laptop, a personal digital assistant (PDA), a notebook, etc.

The website 106 may be an example e-commerce website managed by the merchant. The website 106 displays a variety of products and services for sale to the user 102. Alternatively, the website 106 can be a banking website (issuer website), such as internet banking portal managed by a bank (issuer). The user 102 may have an issuer account associated with the bank (issuer). The user 102 may log in on the website 106 managed by the bank/issuer/issuer server by providing user credentials to access the issuer account of the user 102. The website 106 may display plurality of services selectable by the user 102 for performing an online payment transaction. Examples of services may include, electronic funds transfer, paying payment card (credit card) bills, opening a fixed deposit account/recurring deposit account, adding a beneficiary account, requesting account statements, etc. The website 106 can be a mobile or desktop application, or third-party websites or applications.

A payment transaction between the user 102 (issuer account) and the enterprise/merchant or a beneficiary (acquirer account) may be facilitated by the server system and a payment network 120. Examples of the server system include a first server, an acquirer server 116 and a second server. Without limiting to the scope of present disclosure, the first server is an example of an issuer server 114 and the second server is an example is a payment server 118. In some cases, the issuer server 114, the acquirer server 116 and the payment server 118 can be a single entity, or any two of these servers may be a single entity.

As can be seen from the environment 100, the user 102 is accessing an example e-commerce website 106 on the user device 104 over the Internet. The payment transaction is initiated at the website 106. The payment transaction includes a transaction amount associated with a purchase of goods or services selected from the website 106. The payment transaction is received by the acquirer server 116 which sends it to the first server i.e. the issuer server 114 through the payment network 120 facilitated by the second server i.e. the payment server 118. It shall be noted that initiation of the payment transaction on the website 106 redirects the user 102 to a banking interface (hereinafter referred to as payment authentication interface) on the user device 104. This disclosure and its embodiments describe processes carried out between the user device 104 and a server system after the user is being redirected to the payment authentication interface. The user 102 may have to enter user details such as log in credentials and issuer account details at the payment authentication interface.

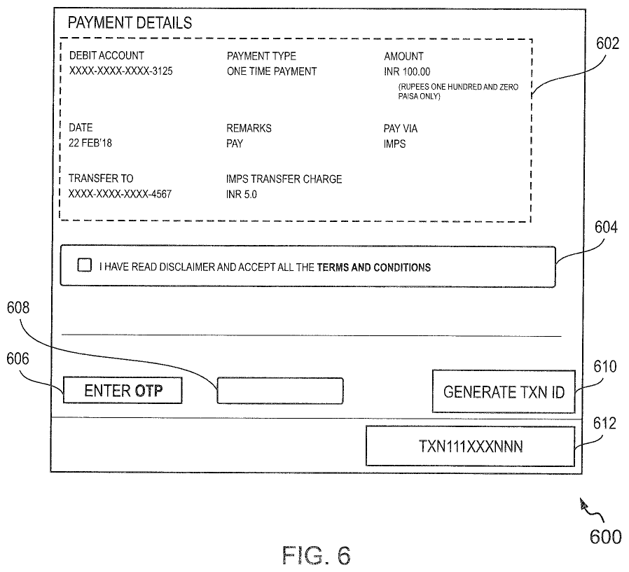

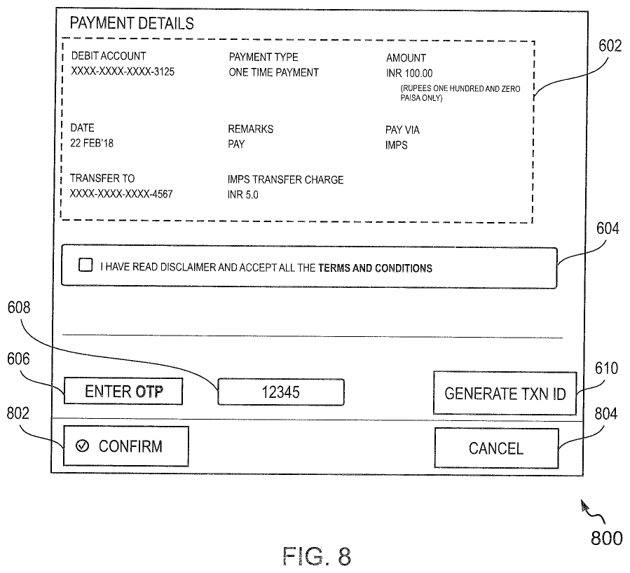

The issuer server 114 (an example of the first server) is associated with a financial institution normally called as an “issuer bank” or “issuing bank” or simply “issuer” or simply “bank”, in which the user 102 may have an issuer account, which issues one or more payment cards, such as a credit card or a debit card. The issuer server 114 or a server linked with the issuer server 114 may be responsible for managing an issuer portal/web site (not shown) such as the website 106. The issuer server 114 further manages a payment authentication interface (see 600 in FIG. 6). The payment authentication interface provides an actionable icon/button (see 610 in FIG. 6) for requesting generation of a transaction ID for the payment transaction. Details of the payment authentication interface will be described later with reference to FIGS. 6 and 8.

The issuer server 114 is further responsible for managing user information of the user 102. The issuer server 114 includes an issuer database (not shown) for maintaining user information such as one or more issuer accounts of the user 102, details of one or more payment cards of the user 102, transaction history related information, permanent account number (PAN) with which the one or more issuer accounts and the one or more payment cards are linked, validity/expiry of payment cards, etc. To complete an online payment transaction, the issuer server 114 authenticates the user 102 and debits funds from the issuer account of the user 102. The payment may be passed to an acquirer account associated with the merchant or a beneficiary to complete the payment transaction. The issuer server 114 further determines whether a regulatory body of issuers mandates a two-step verification in a country where an issuer associated with the issuer server 114 is present. Regulatory body herein refers to a statutory authority or an organization responsible for framing and enforcing regulations for specific institutions under the regulatory body.

The acquirer server 116 is associated with a financial institution normally called as an “merchant bank” or the “acquiring bank” or “acquirer bank” or simply “acquirer”, in which the merchant (or a beneficiary) may have account. The acquirer server 116 is associated with the acquirer bank. In an embodiment, the environment 100 may include a plurality of acquirer servers and a plurality of acquirers associated with the one or more merchants. Similarly, the environment 100 may include a plurality of issuer servers associated with a plurality of issuers, wherein the user 102 may have financial accounts in each of the issuers.

The payment server 118 (an example of the second server) is associated with the payment network 120, where the payment network 120 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard® International Incorporated for the exchange of financial transaction data between financial institutions that are members of Mastercard® International Incorporated. (Mastercard is a registered trademark of Mastercard International Incorporated located in Purchase, N.Y.).

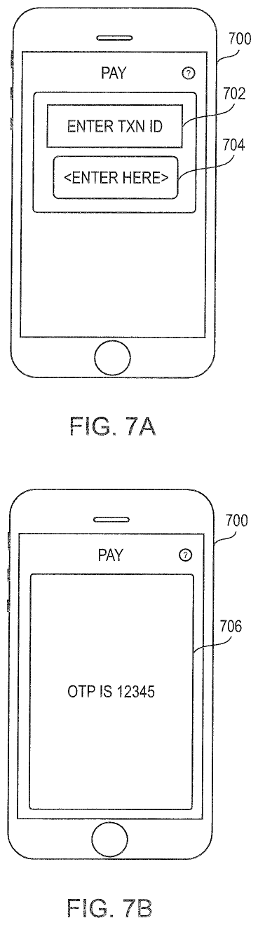

The payment server 118 may facilitate accessing a desktop application or a mobile application at the user device 104. In an example embodiment, the user device 104 may be equipped with an instance of the application installed therein. The application and its components rest in the payment server 118. The application is a set of computer executable codes configured to perform the method disclosed herein. The set of computer executable codes may be stored in a non-transitory computer-readable medium of the user device 104. The application can be extended as a security API (such as Mastercard security API). The user device 104 can communicate with the payment server 118 through the application installed at the user device 104. In other words, the application installed on the user device 104 facilitates an application interface (see 700 in FIGS. 7A and 7B) to enable communication of the user device 104 with the server system (e.g., the payment server 118 and the issuer server 114).

The application interface displays fields of information and enables actionable buttons/icons for selection by the user 102 in order to facilitate a payment transaction. As an example, the application interface facilitates a field for entering a transaction ID (see 704 in FIG. 7A). The application interface facilitates a pop up display for displaying a security code (OTP) (see 706 in FIG. 7B). Details of the application interface will be described later with reference to FIGS. 7A and 7B.

Using the payment network 120 one or more systems of the acquirer/acquirer server 116 will communicate with one or more systems of the issuer/issuer server 114 to determine whether the user's account is in good standing and whether the transaction amount is covered by the user's available account balance. Based on these determinations, authorization of the payment transaction is declined or accepted. When the authorization is accepted, the available balance of user's issuer account is decreased.

The user device 104, the issuer server 114, the acquirer server 116 and the payment server 118 communicate with one another using the network 110. Examples of the network 110 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 110 may be or include the Internet, intranets, extranets, microwave networks, satellite communications, cellular systems, personal communication services (“PCS”), infrared communications, global area networks, or other suitable networks, etc., or any combination of two or more such networks.

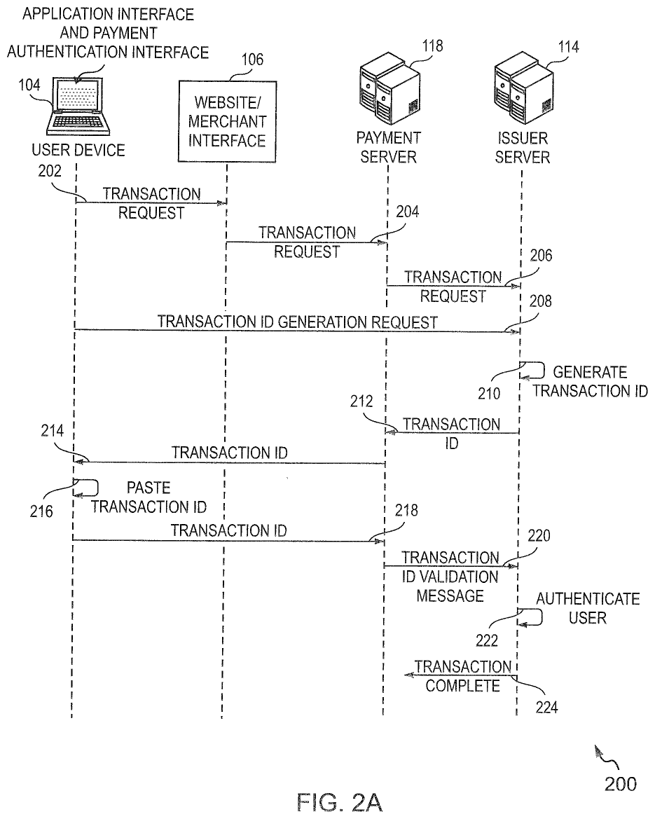

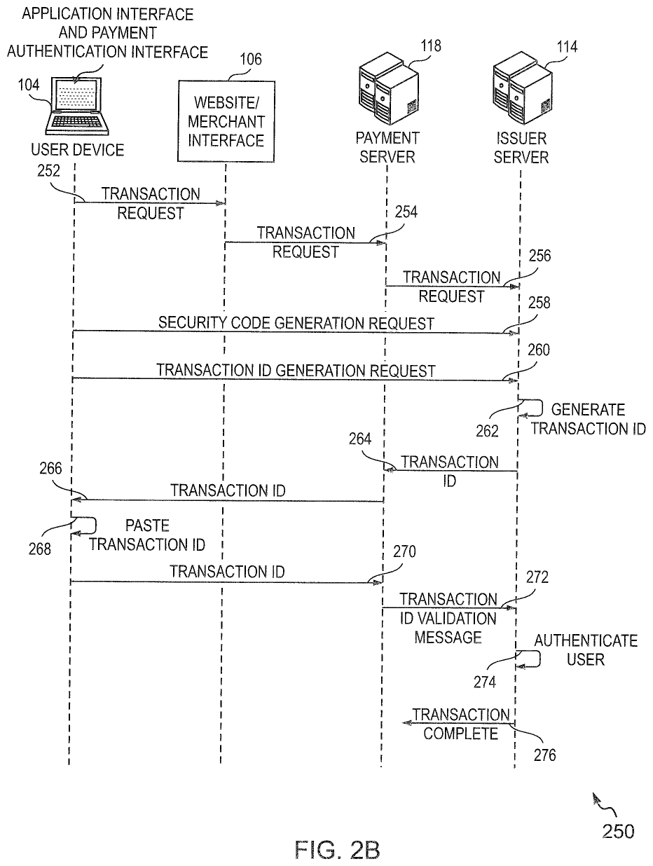

A non-exhaustive example embodiment illustrating facilitating approval of an online payment transaction by an issuer/issuer server (such as the issuer server 114) is described with reference to FIG. 2A. FIG. 2A includes a simplified schematic flow diagram 200 representing a method of facilitating an online payment transaction, in accordance with an example embodiment. As an example, the user 102 has added product to the cart on the website 106 or decided to purchase at the website 106 using the user device 104 and is now redirected to the payment authentication interface associated with the issuer server 114. Without loss of generality, the payment authentication interface is managed by the issuer server 114. It shall be noted that, navigation through the website 106 leads to a payment gateway and redirects the user 102 to the payment authentication interface. It is assumed that the issuer is present in a country where a regulatory body, which governs the financial transaction associated with issuers, has not mandated a two-step verification in that country or geographical location.

At 202, an online payment transaction request is sent from the user device 104 to the website (or merchant interface) 106. It shall be noted that the online payment transaction request is generated at the website 106 displayed at the user device 104 and it is received at a merchant server. The merchant server is an example of the remote web server on which the website 106 is hosted. The transaction request is generated in response to selection of an actionable icon (not shown) on the website 106. Example of such an actionable icon can include a “place order and pay” icon presented on the website 106 which redirects the user 102 to the payment authentication interface. The transaction request may also include information corresponding to the transaction amount, goods/services details, the issuer in which the user 102 has an issuer account and a mode of payment the user 102 prefers, such as, internet banking, payment cards, etc.

At 204, the online payment transaction request is sent from the website 106 (or the merchant server) to the payment server 118. It shall be noted that the transaction request is received at the payment server 118 through an acquirer server (such as the acquirer server 116). The operations performed by the acquirer server 116 is not shown in FIG. 2A for the sake of brevity. At 206, the payment server 118 sends the transaction request to the issuer server 114. It shall be noted that at this instant, the issuer server 114 presents the payment authentication interface at the user device 104. The user 102 may be required to perform a successful login to the payment authentication interface (or a similar separate interface provided by the issuer server such as an online bank account page of the user) by providing user credentials.

At 208, the issuer server 114 receives a transaction ID generation request from the user device 104. The transaction ID generation request is generated in response to the user 102 selecting a transaction ID generation option provided in the payment authentication interface presented at the user device 104. The transaction ID generation option may be an actionable button/icon (see 610 in FIG. 6).

At 210 the issuer server 114 generates the transaction ID. In an embodiment, the transaction ID, thus generated may be valid for only the current/ongoing payment transaction. The issuer server 114 may be configured to generate one transaction ID per transaction to prevent misuse of transaction IDs. The transaction ID, as an example, can be an alphanumeric character of fixed length.

At 212, the transaction ID is sent to the payment server 118 from the issuer server 114 through the payment network 120. At this instant, the issuer server 114 waits for a first pre-defined time-period for a transaction ID validation message to be received from the payment server 118. The pre-defined time period, as an example, is 2 minutes, 4 minutes, etc.

At 214, the transaction ID is sent from the payment server 118 to the application interface presented at the user device 104. The transaction ID may be viewed in the user device 104 in a new tab/window different from the payment authentication interface. Herein, sending the transaction ID to the application interface comprises the payment server 118 and/or the issuer server 114 facilitating automatically copying the transaction ID from the payment authentication page.

At 216, the transaction ID is pasted at the application interface. The user 102 can paste the transaction ID generated by the issuer server 114 in the application interface in an appropriate field (see 704 in FIG. 7A) provided at the application interface. Alternatively, the transaction ID can be manually entered at the application interface presented at user device 104. It shall be noted that, the operations 212 and 214 can be clubbed together as a single operation as it is well understood that the transaction ID is received at the application interface at the user device 104 from the issuer server 114, wherein the application interface is facilitated by the application managed by the payment server 118.

At 218, the upon pasting/manually entering the transaction ID at the application interface, the transaction ID is received at the payment server 118. At 220, a transaction ID validation message is sent to the issuer server 114 from the payment server 118 through the payment network 120. It shall be noted that, the operations 218 and 220 can be clubbed together as a single operation as it is well understood that the transaction ID is received by the issuer server 114 from the application interface on the user device 104, wherein the application interface is facilitated by the application managed by the payment server 118.

Upon reception of the transaction ID validation message or upon reception of a confirmation of provision of the transaction ID at the application interface within the first pre-defined time period (e.g., 4 minutes), the issuer server 114 approves the online payment transaction thereby authenticating the user 102 at 222. As the authentication of the user 102 is performed, the payment transaction is completed (see, at 224) with one or more further steps.

If the issuer server 114 does not receive the transaction ID validation message within the first pre-defined time period, the issuer server 114 may abort the session thereby disabling the payment authentication interface or by showing an error message.

In FIG. 2B, a simplified schematic flow diagram 250 representing a method of facilitating an online payment transaction similar to the method represented by FIG. 2A is illustrated. As described with reference to FIG. 2A, the user is redirected to the payment authentication interface associated with the issuer server 114 after a purchase is being made (or items are added in shopping cart) at the website 106. It shall be noted that the payment authentication interface enables an option for generation of a security code (e.g. OTP).

At 252, an online payment transaction request is sent from the user device 104 to the website (or merchant interface) 106. At 254, the online payment transaction request is sent from the website 106 (or the merchant server) to the payment server 118. At 256, the payment server 118 sends the transaction request to the issuer server 114. It shall be noted that at this instant, the issuer server 114 presents the payment authentication interface at the user device 104. The user 102 may be required to login to the payment authentication interface by providing user credentials.

At 258, the issuer server 114 receives a security code (OTP) generation request from the user device 104. It shall be noted that the issuer server 114 may or may not generate the security code in response to the security code (OTP) generation request. However, due to certain conditions, such as non-availability of SIM or cellular network, failure in cellular network connection or loss of signal as described earlier, the user device 104 may not be capable of receiving an OTP from the issuer server 114. Under such circumstances, the user 102 may wait for a random duration for the security code to be received at the user device 104 until the user 102 selects the transaction ID generation option.

At 260, the issuer server 114 receives a transaction ID generation request from the user device 104. At 262 the issuer server 114 generates the transaction ID. In an embodiment, the transaction ID, thus generated may be valid for only the current/ongoing payment transaction. The issuer server 114 may be configured to generate one transaction ID per transaction to prevent misuse of transaction IDs. The transaction ID, as an example, can be an alphanumeric character of fixed length. In an embodiment, the user can generate the transaction ID generation request in a different window i.e. only after making login to an interface associated with the issuer server 114.

At 264, the transaction ID is sent to the payment server 118 from the issuer server 114 through the payment network 120. At this instant, the issuer server 114 waits for a first pre-defined time-period for a transaction ID validation message to be received from the payment server 118.

At 266, the transaction ID is sent from the payment server 118 to the application interface presented at the user device 104. It is noted that the application interface opens in a new tab/window in the user device 104 different from the payment authentication interface. Herein, sending the transaction ID to the application interface presented at the user device 104 comprises the payment server 118 and/or the issuer server 114 facilitating automatically copying the transaction ID from the payment authentication page.

At 268, the transaction ID is received/pasted at the application interface. The user 102 can paste the transaction ID generated by the issuer server 114 in the application interface in an appropriate field (see 704 in FIG. 7A) provided at the application interface. Alternatively, the transaction ID can be manually entered at the application interface presented at user device 104.

At 270, the upon pasting/manually entering the transaction ID at the application interface, the transaction ID is received at the payment server 118. At 272, a transaction ID validation message is sent to the issuer server 114 from the payment server 118 through the payment network 120.

Upon reception of the transaction ID validation message (see, 272) or upon reception of a confirmation of provision of the transaction ID at the application interface within the first pre-defined time period (e.g., 4 minutes), the issuer server 114 approves the online payment transaction thereby authenticating the user 102 at 274. As the authentication of the user 102 is performed, the payment transaction is completed (see, at 276) with one or more further steps.

If the issuer server 114 does not receive the transaction ID validation message within the first pre-defined time period, the issuer server 114 may abort the session thereby disabling the payment authentication interface or by showing an error message.

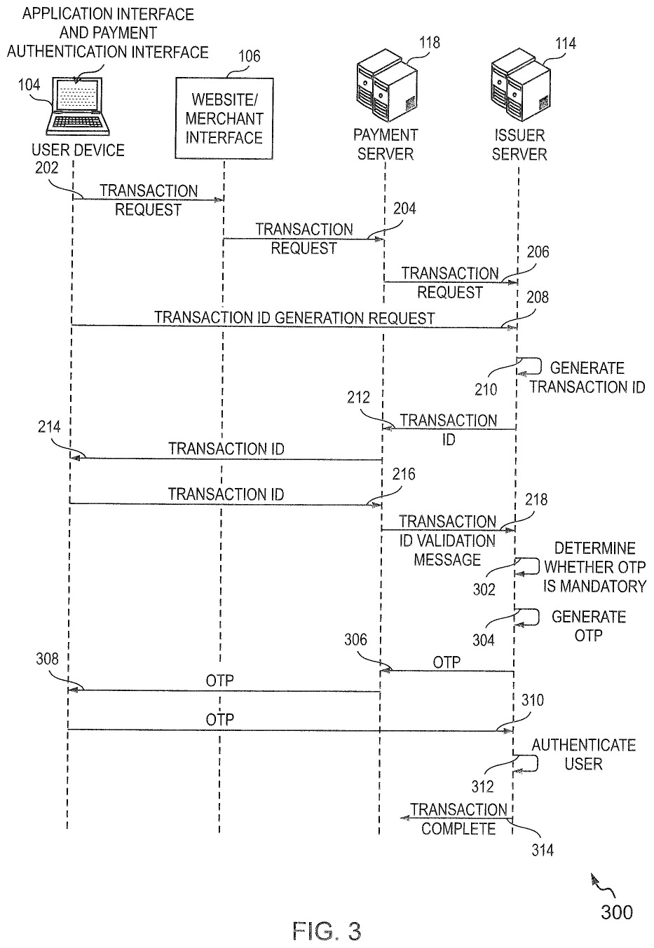

In an embodiment, the issuer associated with the user's issuer account may be present in a country where a regulatory body of issuers has mandated a two-step verification. FIG. 3 includes a simplified sequence flow diagram 300 representing a method of facilitating an online payment transaction, in accordance with another example embodiment. Referring to the above example, the user 102 has made a purchase at a merchant website (such as the website 106) and is now redirected to the authentication page/payment authentication interface associated with the issuer server 114 and managed by the issuer server 114.

The sequence flow diagram 300 includes the operations 202 through 218 carried out between the user device 104/the application interface, the website 106, the payment server 118 and the issuer server 114. The operation steps depicted by 202 to 218 are not described herein for the sake of brevity.

At 302, upon receiving the transaction ID validation message from the payment server 118, within the first pre-defined time period, the issuer server 114 determines whether generation of a security code is mandatory. Generation of the security code is based on one or more pre-defined criteria. One of the pre-defined criteria may be associated with two-step verification process that may be mandated by a regulatory body of issuers (such as the Reserve Bank of India) of a country. The issuer server 114 may include such regulatory information in an issuer database. On the other hand, the issuer server 114 may communicate with a global database that may include such regulatory information concerning two-step verification of payment transactions. There may be several other pre-defined criteria based on which the issuer server 114 generates a security code or determines whether generation of a security code is mandatory. Some example pre-defined criteria include a maximum transaction amount beyond which two-step verification is mandatory, payment regulations in merchant country, payment regulations in a user's residence country, payment regulation for the type of issuer account the user has, etc.

If determined that generation of a security code is mandatory, then at 304, the issuer server 114 generates a security code. The security code can be a one-time password (OTP). One OTP may be generated for one transaction request. The OTP may be a fixed character length string generated randomly by the issuer server 114 using an algorithm. Further, if it is determined that generation of a security code is not mandatory, then the transaction is completed at operation 222 as shown in FIG. 2.

At 306, the security code is sent to the payment server 118 through the payment network 120. At this instant, the issuer server 114 waits for a second pre-defined time period (say 5 mins) for the OTP to be received from the user device 104. At 308, the security code is sent from the payment server 118 to the application interface on the user device 104. The security code is displayed at the application interface. It shall be noted that, the operations 306 and 308 can be clubbed together as a single operation as it is well understood that the security code is sent to the application interface on the user device 104, wherein the application interface is facilitated by the application managed by the payment server 118.

At 310, the user 102 enters the security code manually at the payment authentication interface associated with the issuer server 114 and presented at the user device 104. The payment authentication interface includes a field for receiving the security code (see 608 in FIG. 6). Upon reception of a correct security code from the user 102 within the second pre-defined time period, the issuer server 114 authenticates the user 102 at 312 and the transaction is completed at 314. If the issuer server 114 does not receive the OTP within the second pre-defined time period, the issuer server 114 may abort the session thereby disabling the payment authentication interface or by showing an error message.

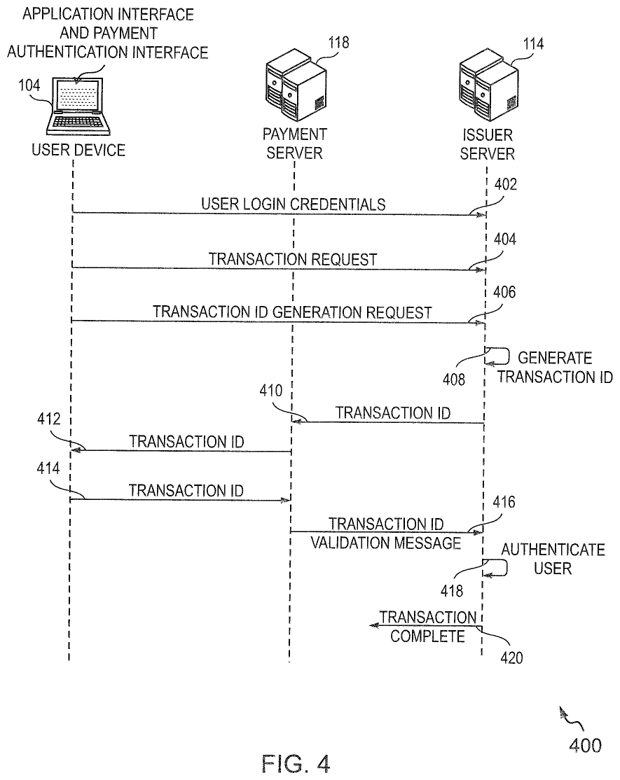

In some example scenarios, the payment transaction can be a transaction initiated at an issuer website (such as the website 106) managed by the issuer server 114. The user 102 may have an issuer account in an issuer bank associated with the website 106. The user 102 may be willing to avail a service presented on the website 106. A payment transaction request may be initiated upon selection of a service. A non-exhaustive example embodiment illustrating approval of an online payment transaction by an issuer/issuer server (such as the issuer server 114) is described with reference to FIG. 4. FIG. 4 includes a simplified sequence flow diagram 400 representing a method of facilitating an online payment transaction, in accordance with yet another example embodiment. As depicted in FIG. 4, the user 102 has logged into the website 106 to access the issuer account of the user 102. It is assumed that the issuer is present in a country where a regulatory body of issuers has not mandated a two-step verification.

At 402, the issuer server 114 receives the user login credentials from the user device 104. In an example scenario, the user log in credentials may include a user ID/customer ID and a login password. Once logged in, the user 102 can select any service facilitated by the issuer and choose to avail the same. It shall be noted that some services may not involve a payment transaction to be performed. Examples of such services may include adding a beneficiary account, requesting for cheque book, changing communication address or contact number of account holder, etc. On the other hand, some services involve a payment transaction. Example of such services may include electronic funds transfer from the issuer account of the user 102 to a beneficiary account. It is assumed that the user has selected funds transfer from the issuer account of the user 102 to a beneficiary account.

At 404, the issuer server 114 receives a transaction request. The transaction request may include a transaction amount, a beneficiary account detail and issuer account detail of the user 102.

At 406, the issuer server 114 receives a transaction ID generation request from the user device 104. Transaction ID generation request has been explained earlier with reference to FIG. 2A (operation 208). At 408, the issuer server 114 generates the transaction ID. Generation of the transaction ID has been explained earlier with reference to FIG. 2A (operation 210).

At 410, the transaction ID is sent to the payment server 118 from the issuer server 114 through the payment network 120. At this instant, the issuer server 114 waits for the first pre-defined time-period (say 4 minutes, 7 minutes, etc.) for the transaction ID to be received from the payment server 118. Herein, sending the transaction ID to the payment server 118 from the issuer server 114 comprises the payment server 118 and/or the issuer server 114 facilitating copying of the transaction ID from the payment authentication page and enabling pasting of the transaction ID at the application interface on the user device 104.

At 412, the transaction ID is sent from the payment server 118 to the application interface present at user device 104. The user 102 can paste the transaction ID generated by the issuer server 114 in the application interface in an appropriate field (704) provided at the application interface. Alternatively, the transaction ID can be manually entered at the application interface presented at user device 104. It shall be noted that, the operations 410 and 412 can be clubbed together as a single operation as it is well understood that the transaction ID is sent from the issuer server 114 to the application interface on the user device 104.

At 414, upon pasting/manually entering the transaction ID at the application interface, the transaction ID is received at the payment server 118. At 416, a transaction ID validation message is sent to the issuer server 114 from the payment server 118 through the payment network 120. It shall be noted that, the operations 414 and 416 can be clubbed together as a single operation as it is well understood that the transaction ID is received by the issuer server 114 from the application interface.

Upon reception of the transaction ID validation message from the payment server 118 or upon reception of a confirmation of provision of the transaction ID at the application interface within the first pre-defined time period, the issuer server 114 approves the online payment transaction thereby authenticating the user 102 at 418. Authentication of the user 102, completes the transaction at 420.

If the issuer server 114 does not receive the transaction ID validation message within the first pre-defined time period, the issuer server 114 may abort the session thereby disabling the payment authentication interface or displaying an error message.

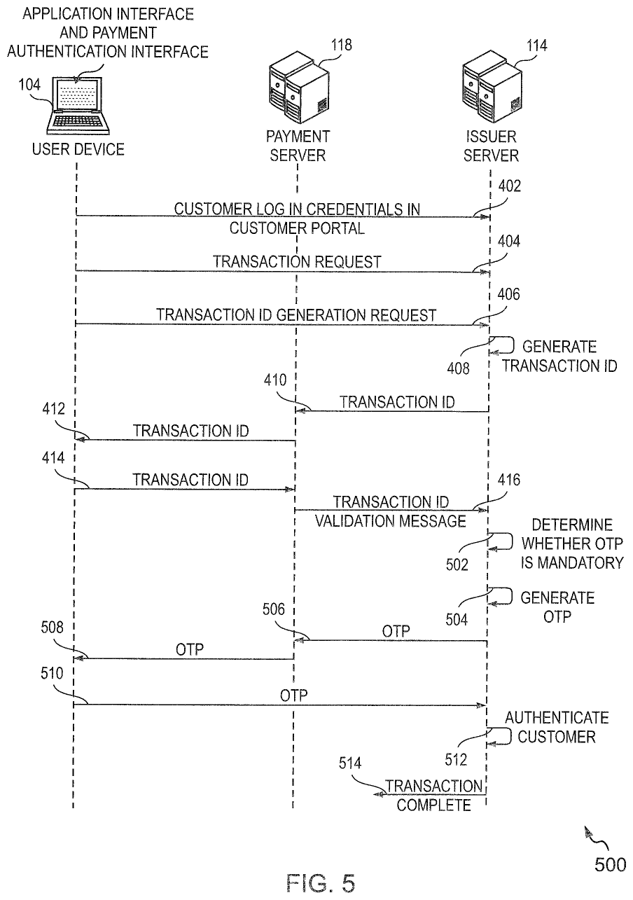

In an embodiment, the issuer associated with the user's issuer account may be present in a country where a regulatory body of issuers have mandated a two-step verification. FIG. 5 includes a simplified sequence flow diagram 500 representing a method of facilitating an online payment transaction, in accordance with still another example embodiment. Referring to the above example, the user 102 has logged into the issuer website 106 to access the issuer account of the user 102 and perform a payment transaction.

The sequence flow diagram 500 includes the operations 402 through 416 carried out between the user device 104/the application interface, the payment server 118 and the issuer server 114. The operation steps depicted by 402 to 416 are not described herein for the sake of brevity.

At 502, upon receiving the transaction ID validation message from the payment server 118, within the first pre-defined time period, the issuer server 114 determines whether generation of a security code is mandatory. If determined, then at 504, the issuer server 114 generates a security code (OTP). The security code is explained with reference to FIG. 3. At 506, the security code is sent to the payment server 118 through the payment network 120. At this instant, the issuer server 114 waits for a second pre-defined time period (say 5 mins) for the security code to be received from the user device 104.

At 508, the security code is sent from the payment server 118 to the application interface presented at the user device 104. The security code is displayed at the application interface. It shall be noted that, the operations 506 and 508 can be clubbed together as a single operation as it is well understood that the security code is sent to the application interface at the user device 104 from the issuer server 114.

At 510, the user 102 enters the security code manually at the payment authentication interface presented at the issuer server 114. The payment authentication interface includes a field for receiving the security code. Upon reception of a correct security code from the user 102 within the second pre-defined time period, the issuer server 114, authenticates the user 102 at 512 and the transaction is completed at 514. If the issuer server 114 does not receive the security code within the second pre-defined time period, the issuer server 114 may abort the session thereby disabling the payment authentication interface or by showing an error message.

FIG. 6 is an example representation of a payment authentication interface/page 600 on an issuer website (such as the website 106) managed by the issuer server 114, in accordance with an example embodiment. The interface 600 shows a plurality of fields of information associated with a payment transaction. A transaction information field 602 displays information associated with a payment transaction. For instance, the field 602 includes details such as issuer account number, payment type (e.g., one-time payment, recurring payment, etc.), transaction amount, date of transaction, a beneficiary/merchant account number, remarks, pay via option (National Electronic Funds Transfer (NEFT), Real Time Gross Settlement (RTGS), Immediate Payment Service (IMPS), etc.) and charges associated with NEFT, RTGS and IMPS payment services. The information present in the field 602 is only for the purposes of explanation. In actual use case, more or less information may be presented than shown in the field 602 and the terms in the fields may vary from the terms used in FIG. 6.

The interface 600 includes a terms and conditions field 604. The terms and conditions field 604 displays a selectable button and a terms and conditions message (e.g., “I have read disclaimer and accept all terms and conditions”) next to the selectable button. The selectable button may have to be mandatorily checked for allowing the user 102 to proceed to the next steps towards completion of the payment transaction.

The interface 600 displays an enter OTP icon 606 (or an enter security code icon) and an OTP field 608 (or a security code field) next to the icon 606. The OTP field 608 is configured to receive the OTP/security code. Once an OTP is generated by the issuer server 114 and displayed to the user 102 at the application interface, the OTP is entered in the field 608 by the user 102 (shown in FIG. 8).

The interface 600 further includes an actionable icon 610 (e.g., “generate Txn ID”) for a transaction ID generate option. Selection of the actionable icon 610 triggers a transaction ID generation request at the issuer server 114. The issuer server 114 generates the transaction ID in response to the request. The transaction ID (e.g., TXN111XXXNNN) is displayed as depicted by transaction ID field 612. The field 612 may be a pop up display or an overlay display placed upon the interface 600. In an example, the issuer server 114 causes automatically copying the transaction ID from the field 612. In another example, the transaction ID may have to be manually copied from the field 612 by functions such as a copy option or a CTRL+C function.

FIG. 7A is an example representation of an application interface 700 facilitated by the payment server and presented on the user device 104 or any other user device, in accordance with an example embodiment. The interface 700 includes a transaction ID receiving icon 702 (e.g., “Enter TXN ID”) and a transaction ID receiving field 704 (e.g., “Enter here”). The transaction ID generated by the issuer server 114 can be pasted in the field 704. Alternatively, the transaction ID generated by the issuer server 114 can be manually entered in the field 704. The transaction ID thus entered triggers a transaction ID validation message sent to the issuer server 114 for approval of the transaction thereby authenticating the user 102.

FIG. 7B is another example representation of the application interface 700 facilitated by the payment server 118 and presented on the user device 104 or any other user device, in accordance with an example embodiment. The application interface 700 provides a pop up display 706, showing the OTP (e.g., 12345) generated in response to reception of the transaction ID validation message by the issuer server 114. It shall be noted that the application interface 700 provides a pop up display 706 upon determination whether generation of a security code is mandatory for the transaction.

FIG. 8 is an example representation of a payment authentication interface/page 800, in accordance with an example embodiment. The payment authentication interface/page 800 is an example of the payment authentication interface/page 600 as seen in FIG. 6 and includes the fields and icons 602, 604, 606, 608 and 610 of the payment authentication interface/page 600. The OTP field 608 receives the OTP (e.g., 12345) displayed at the application interface as seen in FIG. 7B. The payment authentication interface/page 800 provides a confirm icon 802 which is an actionable icon and selection of which sends the OTP to the issuer server 114. The payment authentication interface/page 800 provides a cancel icon 804 which is an actionable icon and selection of which aborts the payment transaction process.

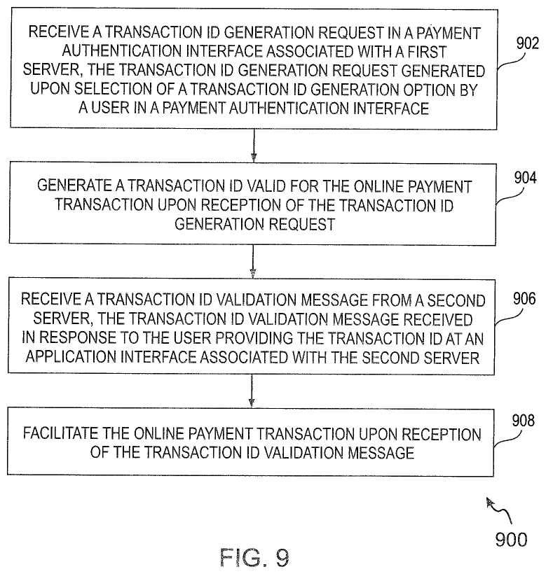

FIG. 9 illustrates a flow diagram of a method 900 for facilitating an online payment transaction, in accordance with one embodiment of the present disclosure. The method 900 depicted in the flow diagram may be executed by, for example, the first server such as the issuer server 114. Operations of the flow diagram 900, and combinations of operation in the flow diagram 900, may be implemented by, for example, hardware, firmware, a processor, circuitry and/or a different device associated with the execution of software that includes one or more computer program instructions. The operations of the method 900 are described herein with help of the first server. It is noted that the operations of the method 900 can be described and/or practiced by using a system other than the first server. The method 900 starts at operation 902.

At 902, the first server receives a transaction ID generation request in a payment authentication interface associated with the first server. The transaction ID generation request is generated upon selection of a transaction ID generation option (see actionable icon 610) by a user (such as the user 102) in the payment authentication interface presented at the user device 104.

At 904, the first server generates a transaction ID valid for the online payment transaction upon reception of the transaction ID generation request. It shall be noted that the transaction ID is valid for only a current online transaction.

At 906, the first server receives a transaction ID validation message from the second server. The transaction ID validation message is received in response to the user providing the transaction ID at an application interface associated with the second server. The application interface may be a desktop application interface or a mobile application interface presented at the user device 104 or any other device associated with the user 102. At this instant, the issuer server 114 waits for a first pre-defined time-period for the transaction ID to be received from the user device 104. The first pre-defined time period, as an example, is 4 minutes.

At 908, the first server facilitates the online payment transaction upon reception of the transaction ID validation message. Upon reception of the transaction ID validation message from the second server or upon reception of a confirmation of provision of the transaction ID by the user at the application interface within the first pre-defined time period (e.g., 4 minutes) the first server approves the online payment transaction thereby authenticating the user 102. If the first server does not receive the transaction ID validation message within the first pre-defined time period, the first server may abort the session thereby disabling the payment authentication interface or by showing an error message.

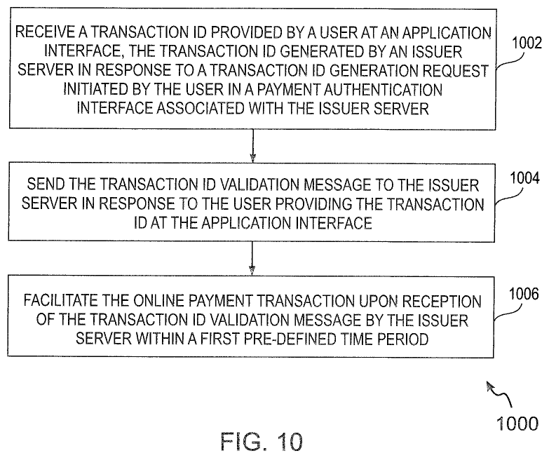

FIG. 10 illustrates a flow diagram of a method 1000 for facilitating an online payment transaction, in accordance with one embodiment of the present disclosure. The method 1000 depicted in the flow diagram may be executed by, for example, the payment server 118. Operations of the flow diagram 1000, and combinations of operation in the flow diagram 1000, may be implemented by, for example, hardware, firmware, a processor, circuitry and/or a different device associated with the execution of software that includes one or more computer program instructions. The operations of the method 1000 are described herein with help of the payment server 118. It is noted that the operations of the method 1000 can be described and/or practiced by using a system other than the payment server 118. The method 1000 starts at operation 1002.

At 1002, the payment server 118 associated with the payment network 120 receives a transaction ID provided by a user at the application interface associated with the payment server 118. The transaction ID is generated by the issuer server 114 in response to a transaction ID generation request initiated by a user (such as the user 102) in the payment authentication interface associated with the issuer server 114. Herein, receiving the transaction ID at the application interface comprises the payment server 118 and/or the issuer server 114 facilitating copying of the transaction ID from the payment authentication page and enabling pasting of the transaction ID at the application interface on the user device 104.

At 1004, the payment server 118 sends a transaction ID validation message to the issuer server 114 through the payment network 120. It shall be noted that the payment server 118 sends the transaction ID validation message to the issuer server 114 in response to the user providing the transaction ID at the application interface associated with the payment server 118. It shall further be noted that the issuer server 114 waits for a first pre-defined time-period for the transaction ID validation message to be received from the payment server 118.

At 1006, the payment server 118 facilitates the online payment transaction upon reception of the transaction ID validation message by the issuer server 114 within the first pre-defined time-period.

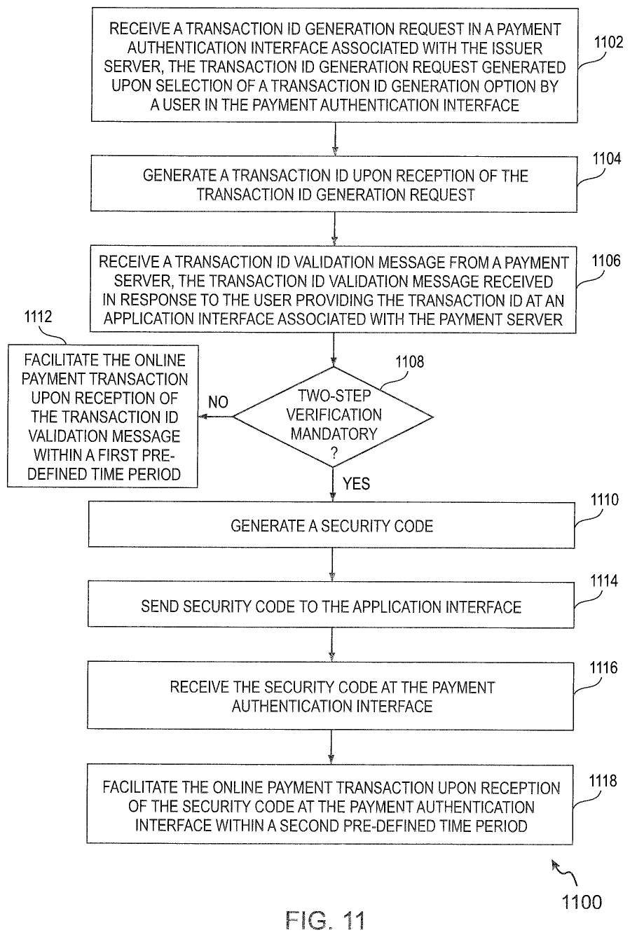

FIG. 11 illustrates a flow diagram of a method 1100 for facilitating an online payment transaction, in accordance with one embodiment of the present disclosure. The method 11000 depicted in the flow diagram may be executed by, for example, the issuer server 114. Operations of the flow diagram 1100, and combinations of operation in the flow diagram 1100, may be implemented by, for example, hardware, firmware, a processor, circuitry and/or a different device associated with the execution of software that includes one or more computer program instructions. The operations of the method 1100 are described herein with help of the issuer server 114. It is noted that the operations of the method 1100 can be described and/or practiced by using a system other than the issuer server 114. The method 11000 starts at operation 1102.

At 1102, the issuer server 114 receives a transaction ID generation request in a payment authentication interface associated with the issuer server 114. The transaction ID generation request is generated upon selection of a transaction ID generation option (see actionable icon 610) by a user (such as the user 102) in the payment authentication interface presented at the user device 104.

At 1104, the issuer server 114 generates a transaction ID upon reception of the transaction ID generation request.

At 1106, the issuer server 114 receives a transaction ID validation message from the payment server 118. The transaction ID validation message is received in response to the user providing the transaction ID at an application interface associated with the payment server 118. The application interface may be a desktop application interface or a mobile application interface presented at the user device 104 or an additional user device.

At 1108, the issuer server 114 determines whether a two-step verification process is mandated for the transaction. In other words, the issuer server 114 verifies or checks if a regulatory body has mandated generation of a security code (OTP) for the transaction based on criteria, such as, the country where the issuer/issuer server 114 is present.

If it is determined that the generation of a security code is mandatory, the issuer server 114 generates a security code at 1110. If it is determined that the generation of a security code is not mandatory, then the issuer server 114 facilitates the online payment transaction upon reception of the transaction ID validation message within the first predefined time period.

Upon generation of the security code at 1110, the issuer server 114, at 1114, sends the security code to the application interface at the user device (such as the user device 104). The security code is displayed to the user 102 at the application interface on the user device 104.

At 1116, the issuer server 114 receives the security code at the payment authentication interface. At 1118, the issuer server 114 facilitates the online payment transaction upon reception of the security code at the payment authentication interface within the second pre-defined time period.

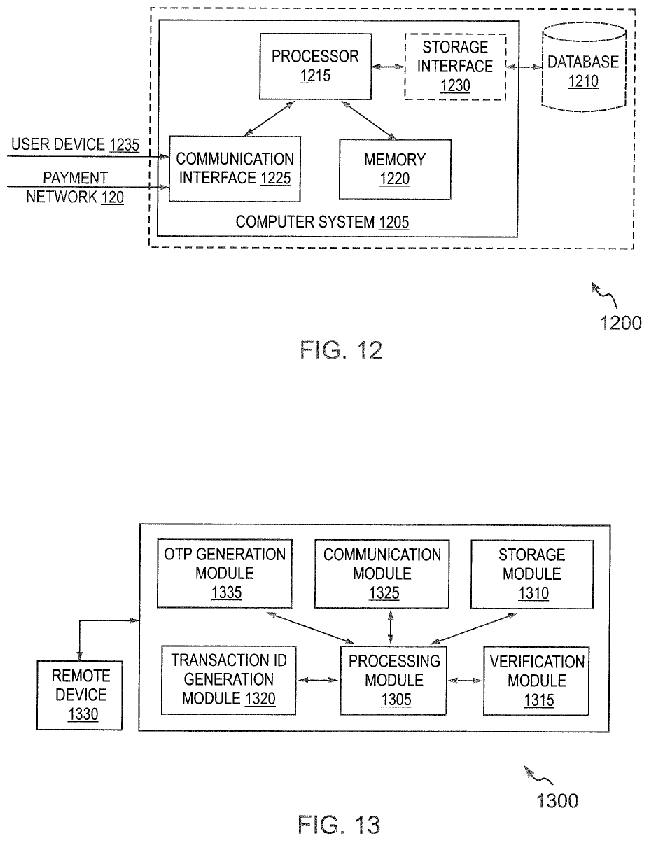

FIG. 12 is a simplified block diagram of a server system 1200 used for facilitating an online payment transaction, in accordance with one embodiment of the present disclosure. The server system 1200 is an example of a server system that is a part of the payment network 120. Examples of the server system 1200 includes, but not limited to, the acquirer server 116, the payment server 118 and the issuer server 114. The server system 1200 includes a computer system 1205 and a database 1210.

The computer system 1205 includes at least one processor 1215 for executing instructions. Instructions may be stored in, for example, but not limited to, a memory 1220. The processor 1215 may include one or more processing units (e.g., in a multi-core configuration).

The processor 1215 is operatively coupled to a communication interface 1225 such that computer system 1205 is capable of communicating with a remote device such as a user device 1235 (e.g., the user device 104) or communicating with any entity within the payment network 120. For example, the communication interface 1225 may receive the payment transaction request, where the payment transaction request is generated in response to a purchase of goods or services from the website 106.

The processor 1215 may also be operatively coupled to the database 1210. The database 1210 is any computer-operated hardware suitable for storing and/or retrieving data, such as, but not limited to, transaction data generated as part of sales activities conducted over the bankcard network including data relating to merchants, account holders or customers, and purchases. The database 1210 may also store information related to a plurality of user's issuer accounts. Each issuer account data includes at least one of a cardholder name, a cardholder address, an account number, MPIN, and other account identifier. The database 1210 may also store information of a plurality of merchants. The database 1210 may also store information associated with a regulatory body of issuers and regulations defined the regulatory body for carrying out payment transactions. The regulations may include rules of verifying/authenticating a user/card holder (such as the user 102) initiating a payment transaction. The database 1210 may also include instructions for settling transactions including merchant bank account information. The database 1210 may include multiple storage units such as hard disks and/or solid-state disks in a redundant array of inexpensive disks (RAID) configuration. The database 1210 may include a storage area network (SAN) and/or a network attached storage (NAS) system.

In some embodiments, the database 1210 is integrated within computer system 1205. For example, computer system 1205 may include one or more hard disk drives as the database 1210. In other embodiments, the database 1210 is external to the computer system 1205 and may be accessed by the computer system 1205 using a storage interface 1230. The storage interface 1230 is any component capable of providing the processor 1215 with access to the database 1210. The storage interface 1230 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1215 with access to the database 1210.

The processor 1215 is configured to facilitate a payment transaction from an issuer account to an acquirer account. The processor 1215 is configured to one or more of the functions such as: verify the merchant, authenticate the user 102, check available standing balance in an issuer account of the user 102, validate the transaction amount. The processor 1215 is further configured to facilitate the authentication of the user 102 by verifying the payment card number, transaction ID and the OTP. Thereafter, the processor 1215 is configured to facilitate the payment transaction of the transaction amount from the issuer account of the user to acquirer account of the merchant. The processor 1215 may also be configured to notify the device 104 of the transaction status via the communication interface 1225.

FIG. 13 is a simplified block diagram of an issuer server 1300 for facilitating an online payment transaction, in accordance with one embodiment of the present disclosure. The issuer server 1300 is an example of the issuer server 114 of FIG. 1, or may be embodied in the issuer server 114. The issuer server 1300 is associated with an issuer bank/issuer, in which a user may have an issuer account, which provides a payment card. The issuer server 1300 includes a processing module 1305 operatively coupled to a storage module 1310, a verification module 1315, a transaction ID generation module 1320, an OTP generation module 1335 and a communication module 1325. The components of the issuer server 1300 provided herein may not be exhaustive and that the issuer server 1300 may include more or fewer components than that of depicted in FIG. 13. Further, two or more components may be embodied in one single component, and/or one component may be configured using multiple sub-components to achieve the desired functionalities. Some components of the issuer server 1300 may be configured using hardware elements, software elements, firmware elements and/or a combination thereof.

The storage module 1310 is configured to store machine executable instructions to be accessed by the processing module 1305. Additionally, the storage module 1310 stores information related to, contact information of the user/customer, bank account number, availability of funds in the account, and/or the like. This information is retrieved by the processing module 1305 for validation during transaction ID generation for the transaction.

The processing module 1305 is configured to communicate with one or more remote devices such as the remote device 1330 using the communication module 1325 over a network such as the network 110 or the payment network 120 of FIG. 1. The examples of the remote device 1330 include, the user device 104, the payment server 118, the acquirer server 116 or other computing systems of issuer and the payment network 120 and the like. The communication module 1325 is capable of facilitating such operative communication with the remote devices and cloud servers using API (Application Program Interface) calls.

The processing module 1305 is further configured to provide instructions to the transaction ID generation module 1320 to generate a transaction ID for each transaction upon reception of transaction ID generation request. The transaction ID generation module 1320 includes a set of algorithms or codes for generating a random alphanumeric character of fixed length. The processing module 1305 is further configured to provide instructions to the OTP generation module 1335 to generate an OTP for each transaction upon verification of regulations whether a transaction may require an OTP. The OTP generation module 1335 includes a set of algorithms or codes for generating random numbers of fixed lengths.

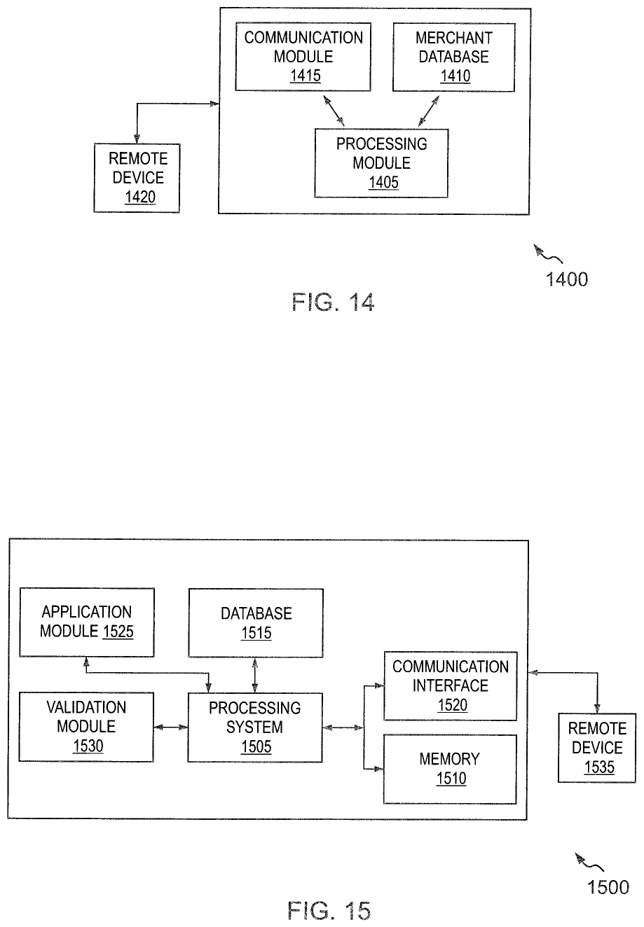

FIG. 14 is a simplified block diagram of an acquirer server 1400 used for facilitating an online payment transaction, in accordance with one embodiment of the present disclosure. The acquirer server 1400 is associated with an acquirer bank, which may be associated with the merchant, where the merchant has established an account to accept payment for purchase from customers. The acquirer server 1400 is an example of the acquirer server 116 of FIG. 1, or may be embodied in the acquirer server 116. Further, the acquirer server 1400 is configured to facilitate payment transaction with the issuer server 1300 using a payment network, such as the payment network 120 of FIG. 1. The acquirer server 1400 includes a processing module 1405 communicably coupled to a merchant database 1410 and a communication module 1415 for communicating to a remote device 1420 such as other server systems or devices associated with the payment network. The components of the acquirer server 1400 provided herein may not be exhaustive, and that the acquirer server 1400 may include more or fewer components than that of depicted in FIG. 14. Further, two or more components may be embodied in one single component, and/or one component may be configured using multiple sub-components to achieve the desired functionalities. Some components of the acquirer server 1400 may be configured using hardware elements, software elements, firmware elements and/or a combination thereof.

The merchant database 1410 includes one or more merchant parameters, such as, but not limited to, a merchant primary account number (PAN), a merchant name, a merchant category code (MCC), a merchant city, a merchant postal code, an MAID, a merchant brand name and the like. The processing module 1405 is configured to use the merchant ID or any other merchant parameter such as the merchant PAN to identify the merchant during the normal processing of payment transactions, adjustments, chargebacks, end-of-month fees and so forth. The processing module 1405 may be configured to store and update the merchant parameters in the merchant database 1410 for later retrieval.

FIG. 15 is a simplified block diagram of a payment server 1500 used for facilitating an online payment transaction, in accordance with one embodiment of the present disclosure. The payment server 1500 may correspond to payment server 118 of FIG. 1. As explained with reference to FIG. 1, the payment server 118 is associated with the payment network 120. The payment network 120 may be used by issuer server 1300 and acquirer server 1400 as a payment interchange network. Examples of payment interchange network include, but not limited to, Mastercard® payment system interchange network. The payment server 1500 includes a processing system 1505 configured to extract programming instructions from a memory 1510 to provide various features of the present disclosure. The components of the payment server 1500 provided herein may not be exhaustive, and that the payment server 1500 may include more or fewer components than that of depicted in FIG. 15. Further, two or more components may be embodied in one single component, and/or one component may be configured using multiple sub-components to achieve the desired functionalities. Some components of the payment server 1500 may be configured using hardware elements, software elements, firmware elements and/or a combination thereof. The database 1515 is any computer-operated hardware suitable for storing and/or retrieving data, such as, but not limited to, information of a plurality of issuer accounts, information of a plurality of merchants, etc. The database 1515 may also store information associated with a regulatory body of issuers and regulations defined the regulatory body for carrying out payment transactions. The database 1515 may also include instructions for settling transactions including merchant bank account information, issuer account information, currency information, various rule sets for performing the payment transaction, etc.

Via a communication interface 1520, the processing system 1505 receives information associated with payment transaction request from a remote device 1535 such as the acquirer server 1400, the user device 104 or the website 106. The communication may be achieved through API calls, without loss of generality. The user details, the payment card details, the issuer account balance, etc., are verified using a validation module 1530. The validation module 1530 may include one or more predefined rule sets using which the processing system 1505 can process the validation. Further, the processing system 1505, upon successful verification, sends transaction amount and the merchant parameters to the acquirer server 1400 for crediting the merchant account with the transaction amount. The processing system 1505 is further configured to notify the remote device 1535 of the transaction status via the communication interface 1520.

In one embodiment, the processing system 1505 provides an application module 1525 for facilitating a dedicated application capable of being installed on the user device 104. The application enables an application interface on the device 104 that receives the transaction ID and displays the OTP. The application module 1525 facilitates a web application or a mobile application. The application module 1525 includes a set of algorithms and codes capable of enabling the application interface at the user device. The application module 1525 further facilitates actionable icons/buttons at the application interface enabling the user 102 to perform the payment transaction. The application interface may be accessed using a web link as well, instead of having a need to install the application on the user device.

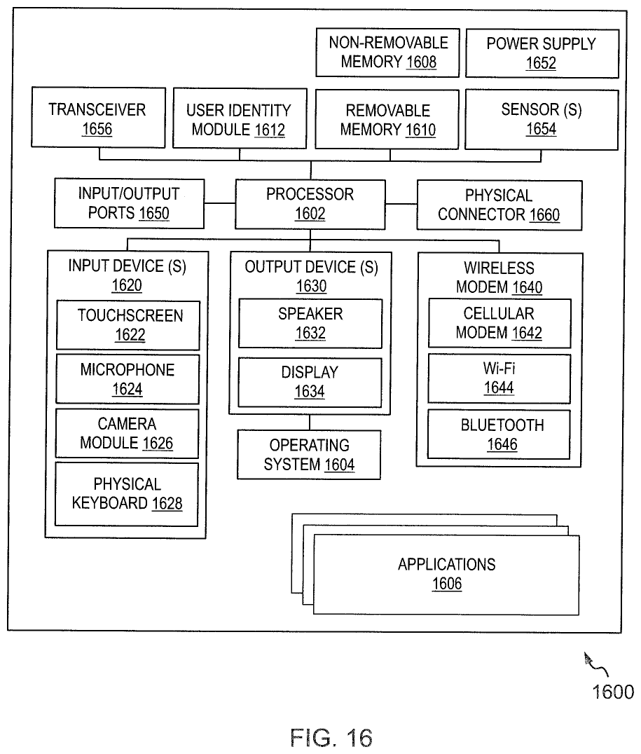

FIG. 16 shows simplified block diagram of a user device 1600 capable of implementing the various embodiments of the present disclosure. For example, the user device 1600 may be an example of the user device 104 or the additional user device. The user device 1600 is depicted to include one or more applications 1606.

It should be understood that the user device 1600 as illustrated and hereinafter described is merely illustrative of one type of device and should not be taken to limit the scope of the embodiments. As such, it should be appreciated that at least some of the components described below in connection with that the user device 1600 may be optional and thus in an example embodiment may include more, less or different components than those described in connection with the example embodiment of the FIG. 16. As such, among other examples, the user device 1600 could be any of an electronic device, for example, cellular phones, tablet computers, laptops, mobile computers, personal digital assistants (PDAs), mobile televisions, mobile digital assistants, desktops or any combination of the aforementioned, and other types of communication or multimedia devices.

The illustrated user device 1600 includes a controller or a processor 1602 (e.g., a signal processor, microprocessor, ASIC, or other control and processing logic circuitry) for performing such tasks as signal coding, data processing, image processing, input/output processing, power control, and/or other functions. An operating system 1604 controls the allocation and usage of the components of the user device 1600 and support for one or more applications programs, that implements one or more of the innovative features described herein. The applications 1606 may include a payment server application facilitating the application interface at the user device 1600. Alternatively or additionally, the applications 1606 may include common mobile computing applications (e.g., telephony applications, email applications, calendars, contact managers, web browsers, messaging applications such as USSD messaging or SMS messaging or SIM Tool Kit (STK) application) or any other computing application.

The illustrated user device 1600 includes one or more memory components, for example, a non-removable memory 1608 and/or removable memory 1610. The non-removable memory 1608 and/or removable memory 1610 may be collectively known as database in an embodiment. The non-removable memory 1608 can include RAM, ROM, flash memory, a hard disk, or other well-known memory storage technologies. The removable memory 1610 can include flash memory, smart cards, or a Subscriber Identity Module (SIM). The one or more memory components can be used for storing data and/or code for running the operating system 1604 and the applications 1606. The user device 1600 may further include a user identity module (UIM) 1612. The UIM 1612 may be a memory device having a processor built in. The UIM 1612 may include, for example, a subscriber identity module (SIM), a universal integrated circuit card (UICC), a universal subscriber identity module (USIM), a removable user identity module (R-UIM), or any other smart card. The UIM 1612 typically stores information elements related to a mobile subscriber. The UIM 1612 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1600 can support one or more input devices 1620 and one or more output devices 1630. Examples of the input devices 1620 may include, but are not limited to, a touch screen/a display screen 1622 (e.g., capable of capturing finger tap inputs, finger gesture inputs, multi-finger tap inputs, multi-finger gesture inputs, or keystroke inputs from a virtual keyboard or keypad), a microphone 1624 (e.g., capable of capturing voice input), a camera module 1626 (e.g., capable of capturing still picture images and/or video images) and a physical keyboard 1628. Examples of the output devices 1630 may include, but are not limited to a speaker 1632 and a display 1634. Other possible output devices can include piezoelectric or other haptic output devices. Some devices can serve more than one input/output function. For example, the touch screen 1622 and the display 1634 can be combined into a single input/output device.

A wireless modem 1640 can be coupled to one or more antennas (not shown in the FIG. 16) and can support two-way communications between the processor 1602 and external devices, as is well understood in the art. The wireless modem 1640 is shown generically and can include, for example, a cellular modem 1642 for communicating at long range with the mobile communication network, a Wi-Fi compatible modem 1644 for communicating at short range with an external Bluetooth-equipped device or a local wireless data network or router, and/or a Bluetooth-compatible modem 1646. The wireless modem 1640 is typically configured for communication with one or more cellular networks, such as a GSM network for data and voice communications within a single cellular network, between cellular networks, or between the mobile phone 1600 and a public switched telephone network (PSTN).

The user device 1600 can further include one or more input/output ports 1650, a power supply 1652, one or more sensors 1654 for example, an accelerometer, a gyroscope, a compass, or an infrared proximity sensor for detecting the orientation or motion of the mobile phone 1600 and biometric sensors for scanning biometric identity of an authorized user, a transceiver 1656 (for wirelessly transmitting analog or digital signals) and/or a physical connector 1660, which can be a USB port, IEEE 1294 (FireWire) port, and/or RS-232 port. The illustrated components are not required or all-inclusive, as any of the components shown can be deleted and other components can be added.

Without in any way limiting the scope, interpretation, or application of the claims appearing below, a technical effect of one or more of the example embodiments disclosed herein is to provide computer implemented methods and server systems for approving an online transaction carried out over the Internet by authenticating an identity of a user. The system provides a server system, which facilitates generation of a transaction ID for authentication of a payment transaction in scenarios where an OTP cannot be received at a registered mobile number of a user for authentication of an online transaction. The solution provides a payment authentication interface (internet banking) which provides an option to request generation of a transaction ID for a current transaction. The solution further provides an application interface for entering the transaction ID. Upon entering the transaction ID at the application interface, a security code (OTP) is generated and displayed at the application interface. The OTP can be entered at the payment authentication interface for authentication of the payment transaction. The solution can enable a single step verification/authentication and as well as a two-step verification authentication of the user for approving the online transaction.

The disclosed methods with reference to FIGS. 1 to 16 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1200 and various components such as the computer system 1205 and the database 1210 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method for facilitating an online payment transaction, the method comprising:
receiving, by a first server associated with a payment network, a transaction identifier (ID) generation request in a payment authentication interface associated with the first server, the transaction ID generation request generated upon selection of a transaction ID generation option by a user in the payment authentication interface;
generating, by the first server, a transaction ID valid for the online payment transaction upon reception of the transaction ID generation request;
receiving a transaction ID validation message from a second server associated with the payment network, the transaction ID validation message received in response to the user providing the transaction ID at an application interface associated with the second server; and
upon receiving the transaction ID validation message, facilitating, by the first server, the online payment transaction.

2. The method as claimed in claim 1, wherein the first server is an issuer server and the second server is a payment server.

3. The method as claimed in claim 2, further comprising:
generating, by the issuer server, a security code in response to reception of the transaction ID validation message;
sending, by the issuer server, the security code to the application interface;
receiving, by the issuer server, the security code in the payment authentication interface associated with the issuer server; and
performing the online payment transaction upon reception of the security code in the payment authentication interface.

4. The method as claimed in claim 3, wherein the online payment transaction is performed when the transaction ID validation message is received within a first pre-defined time period of generation of the transaction ID, and when the security code is received within a second pre-defined time period of generation of the security code.

5. The method as claimed in claim 3, wherein the security code is a one-time password (OTP).

6. The method as claimed in claim 3, wherein generating the security code further comprises generating the security code based on one or more pre-defined criteria.

7. The method as claimed in claim 6, wherein the one or more pre-defined criteria comprise whether a regulatory body for controlling the online payment transaction has mandated a two-step verification for online payment transactions.

8. The method as claimed in claim 1, further comprising facilitating provision of automatically copying of the transaction ID from the payment authentication interface in a user device to paste the transaction ID in the application interface.

9. The method as claimed in claim 1, wherein facilitating the online payment transaction comprises performing the online payment transaction when the transaction ID validation message is received within a first pre-defined time period of generation of the transaction ID.

10. The method as claimed in claim 1, further comprising enabling an option for generation of a security code at the payment authentication interface.

11. The method as claimed in claim 1, further comprising receiving a security code generation request upon selection of the option for generation of the security code at the payment authentication interface prior to receiving the transaction ID generation request.

12. An issuer server for facilitating an online payment transaction, the issuer server comprising:
a memory comprising stored instructions; and
a processor configured to execute the stored instructions thereby causing the issuer server to perform at least:
receiving a transaction identifier (ID) generation request in a payment authentication interface associated with the issuer server, the transaction ID generation request generated upon selection of a transaction ID generation option by a user in the payment authentication interface;
generating a transaction ID valid for the online payment transaction upon reception of the transaction ID generation request;
receiving a transaction ID validation message from a payment server associated with a payment network, the transaction ID validation message received in response to the user providing the transaction ID at an application interface associated with the payment server;
upon receiving the transaction ID validation message, facilitating the online payment transaction.

13. The issuer server as claimed in claim 12, further caused to perform at least:
generating a security code in response to reception of the transaction ID validation message;
sending the security code to the application interface;
receiving the security code in the payment authentication interface associated with the issuer server; and
performing the online payment transaction upon reception of the security code in the payment authentication interface.

14. The issuer server as claimed in claim 13, wherein the issuer server is caused to perform the online payment transaction when the transaction ID validation message is received within a first pre-defined time period of generation of the transaction ID, and when the security code is received within a second pre-defined time period of generation of the security code.

15. The issuer server as claimed in claim 12, wherein the security code is at least a onetime password (OTP).

16. The issuer server as claimed in claim 12, wherein the issuer server is further caused to generate the security code based on one or more pre-defined criteria.

17. The issuer server as claimed in claim 16, wherein the one or more pre-defined criteria comprise whether a regulatory body for controlling the online payment transaction has mandated a two-step verification for online payment transactions.

18. The issuer server as claimed in claim 12, wherein the issuer server is further caused to facilitate provision of automatically copying of the transaction ID from the payment authentication interface in a user device to paste the transaction ID in the application interface.

19. The issuer server as claimed in claim 12, wherein for facilitating the online payment transaction, the issuer server is further caused to perform the online payment transaction when the transaction ID validation message is received within a first pre-defined time period of generation of the transaction ID.

20. The issuer server as claimed in claim 12, wherein the issuer server is further caused to facilitate an option to request for generation of security code at the payment authentication interface prior to receiving the transaction ID generation request.

21. The issuer server as claimed in claim 20, wherein the issuer server is further caused to facilitate the transaction ID generation request in response to a successful login by the user in the payment authentication interface.

22. A method for facilitating an online payment transaction, the method comprising:
receiving, by a payment server associated with a payment network, a transaction ID provided by a user at an application interface associated with the payment server, the transaction ID generated by an issuer server associated with the payment network in response to a transaction ID generation request initiated by the user in a payment authentication interface associated with the issuer server;
sending a transaction ID validation message to the issuer server through the payment network in response to the user providing the transaction ID at the application interface associated with the payment server; and
facilitating the online payment transaction upon reception of the transaction ID validation message by the issuer server within a first pre-defined time period.

23. The method as claimed in claim 22, further comprising:
receiving, by the payment server, a security code from the issuer server, the security code generated by the issuer server in response to reception of the transaction ID validation message; and
facilitating display of the security code at the application interface associated with the payment server.

24. The method as claimed in claim 23, wherein receiving the security code further comprises receiving the security code based on one or more pre-defined criteria, the one or more pre-defined criteria comprising whether a regulatory body for controlling the online payment transaction has mandated a two-step verification for online payment transactions.

25. The method as claimed in claim 23, wherein facilitating the online payment transaction further comprises facilitating authentication of the user by the issuer server upon reception of the transaction ID validation message by the issuer server within a first pre-defined time period.
